(19) United States
(12) Patent Application Publication
(10) Pub. No.: US 2011/0143245 A1
(43) Pub. Date: Jun. 16, 2011

(54) FUEL CELL SYSTEM

(75) Inventors: Yoshitaka KAWASAKI, Mie (JP); Terumaru Harada, Nara (JP); Takashi Nishikawa, Nara (JP)

(73) Assignee: PANASONIC CORPORATION, Osaka (JP)

(21) Appl. No.: 13/032,204

(22) Filed: Feb. 22, 2011

Related U.S. Application Data
(62) Division of application No. 11/596,925, filed on Nov. 17, 2006.

(30) Foreign Application Priority Data
May 19, 2004 (JP) 2004-148656

(51) Int. Cl. H01M 8/04

(52) U.S. Cl. 429/429

(57) ABSTRACT

A fuel cell system comprising: a fuel cell (1); a cooling water tank (7) and a cooling water circulation passage (32); a hot water tank (10) and a hot water circulation passage (31); a heat exchanger (9); drain valves (25) to (27); temperature sensors (17), (18), (20); and a controller (41), wherein the controller selects circulation of at least either cooling water in the cooling water circulation passage or hot water in the hot water circulation passage, or alternatively selects water discharge by opening the drain valves, based on the water temperatures detected by the temperature sensors during suspension of the power generation of the fuel cell.

### TECHNICAL FIELD

The present invention relates to a fuel cell system and more particularly to a cogeneration system equipped with a fuel cell that generates electric power by use of fuel gas and oxidizing gas.

### BACKGROUND ART

Fuel cell systems capable of high-efficiency small-scaled power generation have been heretofore suitably used as a distributed power generation system, since a system architecture for utilizing heat energy generated by power generation in these fuel cell systems is easy to construct and they provide high energy utilization efficiency.

Fuel cell systems have a fuel cell stack (hereinafter simply referred to as “fuel cell”) as the main body of the power generation section. As a fuel cell, polymer electrolyte fuel cells and phosphoric acid fuel cells are widely used. Among them, polymer electrolyte fuel cells are able to perform stable power generation operation at relatively low temperatures and therefore are suited for use as a fuel cell that constitutes a fuel cell system.

A polymer electrolyte fuel cell includes, as its electrolyte membrane, a polymer ion exchange membrane such as a fluorocarbon polymer ion exchange membrane having a sulfonic acid group. The faces of the electrolyte membrane such as a polymer ion exchange membrane are provided with a fuel electrode (anode) and an oxygen electrode (cathode), respectively, which are made from e.g., a platinum catalyst. These fuel and oxygen electrodes respectively include a porous carbon electrode. Thus, a membrane-electrode assembly (abbreviated by MEA) is constructed in a polymer electrolyte fuel cell. This membrane-electrode assembly is sandwiched by separators each having passages for the fuel gas, oxidizing gas and cooling water, thereby forming an electric cell. A multiplicity of such electric cells are stacked to form a polymer electrolyte fuel cell.

In such a polymer electrolyte fuel cell, a hydrogen gas or hydrogen-rich fuel gas (e.g., reformed gas) is supplied to the fuel electrode side during power generating operation. An oxidizing gas (e.g., air) containing oxygen is supplied as an oxidant to the oxygen electrode side. Then, in this polymer electrolyte fuel cell, hydrogen ions generated on the fuel electrode move onto the oxygen electrode within the electrolyte membrane in the presence of water. At the oxygen electrode, the hydrogen ions chemically react with electrons which have reached the oxygen electrode by way of the external load and react with oxygen present in air supplied to the oxygen electrode side, so that water is produced. As just described, electrons move from the fuel electrode to the oxygen electrode by way of the external load, and this flow of electrons is utilized as electric energy by the external load connected to the fuel cell system.

In this polymer electrolyte fuel cell, heat is generated by the above reaction during the power generation operation. This heat is continuously recovered by cooling water flowing in a passage formed in the separators. Where the user of the fuel cell system needs only electric energy, the heat continuously recovered by the cooling water is continuously discharged outwardly from the fuel cell system by a radiator or the like. On the other hand, where the user requires heat energy in addition to electric energy (i.e., cogeneration), the cooling water which has been continuously discharged from the fuel cell and risen in temperature is supplied to the heat load directly or after temporarily stored in a hot water tank etc.

In the polymer electrolyte fuel cell, the electrolyte membrane needs to be kept in a good water-retaining condition in order to cause the polymer ion exchange membrane serving as the electrolyte member to fully exert its hydrogen ion permeability. Therefore, the conventional polymer electrolyte fuel cells are configured such that at least either the fuel gas or oxidizing gas contains vapor in an amount that saturates at temperatures in the vicinity of a power generation operation temperature (e.g., temperatures in the range of from room temperature to 100° C.). Thereby, the electrolyte membrane can be kept in a good water-retaining condition so that the fuel cell system can exert desired power generation performance.

As described earlier, a fuel cell system is provided with many passages and water storage tanks such as: a passage in which the cooling water flows for continuously recovering heat generated in the polymer electrolyte fuel cell during the power generation operation; a hot water passage in which hot water flows for providing the heat load with heat energy recovered by the cooling water; and a hot water tank for storing the hot water. Flowing of the water/hot water in these passages, storage of the water/hot water in the water storage tanks, cooling of the polymer electrolyte fuel cell, and supplying heat energy to the heat load are properly done, whereby the fuel cell system can exert desired performance as a cogeneration system.

The conventional fuel cell systems can exert desired power generation performance since the electrolyte membrane, water passages, water storage tanks etc. are kept warm by heat generated by the polymer electrolyte fuel cell etc. in the power generation operation. However, during a power generation suspension period, the polymer electrolyte fuel cell etc. does not generate heat so that the electrolyte membrane, water passages, water storage tanks etc. cannot be kept warm. That is, the fuel cell systems are liable to heat dissipation and cooling during the power generation suspension period. The fuel cell systems easily radiate heat and cool down to a temperature lower than the freezing point during the power generation suspension period, particularly, in winter in cold districts.

If the power generation suspension state of the fuel cell system continues for a long time more than several hours in an extremely cold region where the ambient temperature reaches 20° C. below freezing in winter time or in a cold district where the minimum temperature is below the freezing point, it sometimes happens that the water contained in the electrolyte membrane of the polymer electrolyte fuel cell becomes frozen and the tissue structure of the electrolyte membrane serving as a retainer for the water is broken. Further, water is sometimes frozen in the water passages, the water storage tanks etc. In short, it sometimes happens that the fuel system malfunctions, failing in providing desired power generation performance or specified performance as a cogeneration system. In such a case, the main body of the polymer electrolyte fuel cell, the water passages, the water storage tanks, etc. are sometimes destroyed by freeze-up accompanied with expansion.

To prevent freezing of water in a fuel cell system during a power generation suspension period, there has been proposed a fuel cell system according to which the casing for storing the fuel cell main body is provided with a heater to entirely heat the fuel cell and keep it warm (see e.g., Patent Document 1).

Another attempt to prevent freezing of water in a fuel cell system during a power generation suspension period is such that the water passages are provided with an electromagnetic valve which is opened according to necessity to discharge water from the fuel cell system with the aid of a pump (see e.g., Patent Document 2).

Another attempt to prevent freezing of water in a fuel cell system during a power generation suspension period is such that a water heater is provided to heat cooling water to produce hot water which is in turn circulated within the fuel cell system (see e.g., Patent Document 3)

Patent Document 1: Publication (KOKAI) of Patent Application No. 2001-351652

Patent Document 2: Publication (KOKAI) of Patent Application No. Hei.11-273704

Patent Document 3: Publication (KOKAI) of Patent Application No. 2002-246052

### DISCLOSURE OF THE INVENTION

### Problems that the Invention is to Solve

These conventional proposals for preventing water freezing, however, have revealed drawbacks in economical efficiency in the maintenance/upkeep of the fuel cell system, operability and safety/security.

In fact, it is practically difficult for fuel cell systems to prevent freezing of water, for instance, by providing the casing for housing the fuel cell body with a heater to heat the whole fuel cell and keep it warm or by providing a water heater to heat cooling water so that hot water is produced and circulated. The reason for this is that fuel cell systems are constituted by elements which have high heat capacity and large volume such as the pretreatment system for humidifying the fuel gas and oxidizing gas; the polymer electrolyte fuel cell in which a large amount of cooling water circulates; and the hot water tank for storing a large amount of hot water. In short, fuel cell systems are cogeneration systems of high heat capacity and large volume. Therefore, provision of an extremely large-scaled heater capable of providing a large amount of heat is essential for prevention of water freezing within a fuel cell system during a power generation suspension period, because the amount of heat generated by a small-scaled heater is insufficient.

If a supply of electric power is not required and therefore the power generation operation is stopped over a long period of time in an extremely cold region or cold district, it is necessary to prevent water freezing until the power generation operation of the fuel cell system is started again. In such a case, a large amount of electric power needs to be consumed to operate the above-described extremely large-scaled heater for a long time. This imposes a large economic burden on the user of the fuel cell system.

The proposal, in which the water passages are provided with an electromagnetic valve and water freezing is prevented by discharging water from the fuel cell system using a pump, is surely reliable in view of prevention of water freezing (the cause of interference). Additionally, this proposal can be easily implemented only by a short-time operation such as opening of the electromagnetic valve and therefore has the advantage that consumption of a large amount of energy is unnecessary. However, since water has been discharged from the fuel cell system and therefore, the inside of the fuel cell system needs to be refilled with a sufficient amount of water when restarting the fuel cell system after a stop of the power generation operation. Therefore, a time loss is caused by the filling of the fuel cell system with water when restarting. In addition, if unpurified water is used when filling the fuel cell system with water newly fed from outside, there is a risk that the cooling water used for cooling the polymer electrolyte fuel cell might be contaminated with impurities. If the cooling water contains impurities, it directly affects the power generation performance of the polymer electrolyte fuel cell. For this reason, the water to be newly supplied must be purified to a high degree in order to keep the cooling water in a desirable condition. This again brings a time loss and economic burden to the user of the fuel cell system.

The proposal, in which water is discharged from the fuel cell system, has proved unsuccessful in perfectly preventing water freezing for the reason that effective use of hot water in the hot water tank is required during a power generation operation suspension period and therefore the hot water tank cannot be simply emptied. Therefore, there still remains a need for another measure for preventing freezing of the hot water within the hot water tank, apart from the water discharge described earlier.

The invention is directed to overcoming the foregoing problems and a primary object of the invention is therefore to provide a fuel cell system capable of preventing damage caused by freezing of water to maintain and ensure safe power generation operation, while restricting energy losses, operational complexity and a lack of maneuverability.

### Means of Solving the Problems

In accomplishing these and other objects, there has been provided, in accordance with the present invention, a fuel cell system comprising:
a fuel cell for generating electric power by use of a fuel gas containing hydrogen and an oxidizing gas containing oxygen;
a cooling water tank for storing cooling water;
a cooling water circulation passage for circulating the cooling water by way of the cooling water tank to recover heat generated by the power generation of the fuel cell, thereby cooling the fuel cell;
a hot water tank for storing hot water;
a hot water circulation passage for circulating the hot water by way of the hot water tank;
a heat exchanger for making a heat exchange between the cooling water circulating in the cooling water circulation passage and the hot water circulating in the hot water circulation passage;
drain valves for discharging water from at least either the cooling water circulation passage or the cooling water tank and from at least either the hot water circulation passage or the hot water tank, respectively;
temperature sensors for detecting water temperature in at least either the cooling water circulation passage or the cooling water tank and in at least either the hot water circulation passage or the hot water tank, respectively; and
a controller,
wherein the controller selects circulation of at least either the cooling water in the cooling water circulation passage or the hot water in the hot water circulation passage, or alternatively selects water discharge by opening the drain valves, based on the water temperatures detected by the temperature sensors during suspension of the power generation of the fuel cell.

In the above fuel cell system, since the controller selects circulation of at least either the cooling water in the cooling water circulation passage or the hot water in the hot water circulation passage or alternatively selects water discharge by opening the drain valves, based on the water temperatures detected by the temperature sensors during suspension of power generation of the fuel cell, water freezing in the fuel cell system can be prevented without fail without consuming a large amount of energy and causing a time loss.

The above fuel cell system further comprises:
a feed water tank for replenishing the cooling water tank with water;
a makeup water circulation passage for circulating the water between the cooling water tank and the feed water tank;
a drain valve for discharging water from at least either the makeup water circulation passage or the feed water tank; and
a temperature sensor for detecting water temperature in at least either the makeup water circulation passage or the feed water tank.

Since the fuel cell system is further provided with the makeup water circulation passage for circulating water to be replenished to the cooling water tank; the feed water tank for storing the makeup water; the drain valve for discharging water from at least either the makeup water circulation passage or the feed water tank; and the temperature sensor for detecting water temperature in at least either the makeup water circulation passage or the feed water tank, freezing of the water to be replenished to the cooling water tank of the fuel cell system can be prevented.

In the fuel cell system, if the water temperature detected by either of the temperature sensors is below a specified threshold temperature, at least either the cooling water or the hot water is circulated, and then, if the water temperatures detected by both of them become lower than below the specified threshold temperature, the drain valves are opened to discharge water.

Since the fuel cell system is designed such that when the water temperature detected by either of the temperature sensors is below the specified threshold temperature, at least either the cooling water or the hot water is circulated and then, if the water temperatures detected by both temperature sensors become lower than the specified threshold temperature, the drain valves are opened to discharge water, water freezing in the fuel cell system can be effectively prevented.

In the fuel cell system, at least either the cooling water tank or the cooling water circulation passage has a first heater for heating the cooling water.

Since at least the cooling water tank or the cooling water circulation passage is provided with the first heater for heating the cooling water, the cooling water can be heated according to need.

In the fuel cell system, at least either the hot water tank or the hot water circulation passage has a second heater for heating the hot water.

Since at least the hot water tank or the hot water circulation passage is provided with the second heater for heating the hot water, the hot water can be heated according to need.

The above fuel cell system further comprises: a reformer for generating the fuel gas by reforming a material containing an organic compound composed of at least carbon and hydrogen; a third heater for heating the reformer to a specified reforming temperature and maintaining the reformer at the reforming temperature; a devious passage that is provided in at least either the cooling water circulation passage or the hot water circulation passage so as to pass through the third heater; and a passage selector valve for switching to the devious passage. The devious passage is designed to be partially heated by the third heater.

Since the devious passage is partly heated by the third heater, at least either the cooling water flowing in the cooling water circulation passage or the hot water flowing in the hot water circulation passage can be heated according to need, while passing through the devious passage.

The fuel cell system further comprises: normally-closed type electromagnetic valves serving as the drain valves; outside air temperature sensors each of which is configured to detect the temperature of outside air in the neighborhood of its corresponding normally-closed type electromagnetic valve; electric accumulators for storing electric energy that has been generated through the power generation of the fuel cell and is used for opening the normally-closed type electromagnetic valves; and second controllers. In the event of electric failure, the second controllers operate, according to the outside air temperatures detected by the outside air temperature sensors, such that the electric accumulators supply the electric energy to the normally-closed type electromagnetic valves to open them, thereby discharging water.

Since the second controllers operate according to the outside air temperatures detected by the outside air temperature sensors in the event of power failure such that the electric accumulators supply the electric energy to the normally-closed type electromagnetic valves to open them, thereby discharging water, water freezing in the fuel cell system can be prevented without fail in case of power failure.

In the above fuel cell system, if the outside air temperatures detected by the outside air temperature sensors when electric power fails are lower than the specified threshold temperature, the second controllers operate such that the electric accumulators supply the electric energy to the normally-closed type electromagnetic valves to open them, thereby discharging water.

Since if the outside air temperatures detected by the outside air temperature sensors are lower than the specified threshold temperature when electric power fails, the second controllers control the electric accumulators so as to supply the electric energy to the normally-closed type electromagnetic valves to open them, thereby discharging water, water freezing in the fuel cell system can be effectively prevented in case of power failure.

In the above fuel cell system, the controller further comprises a first mode selection command input unit for selecting a long-term stop of the power generation of the fuel cell. If a command instructive of selecting the long-term operation stop is input to the controller through the first mode selection command input unit, the controller opens the drain valves to discharge water, and if a command instructive of selecting the long-term operation stop is not input to the controller and the water temperature detected by either of the temperature sensors is lower than the specified threshold temperature, the controller allows at least either circulation of the cooling water in the cooling water circulation passage or circulation of the hot water in the hot water circulation passage.

Since the controller further comprises a first mode selection command input unit used for selecting the long-term stop of the power generation of the fuel cell, and if a command instructive of selecting the long-term operation stop is input to the controller through the first mode selection command input unit, the controller opens the drain valves to discharge water, whereas if a command instructive of selecting the long-term operation stop is not input to the controller and the water temperature detected by either of the temperature sensors is lower than the specified threshold temperature, the controller allows at least either circulation of the cooling water in the cooling water circulation passage or circulation of the hot water in the hot water circulation passage, water freezing in the fuel cell system can be properly prevented without fail, according to the situation.

In the fuel cell system, if a command instructive of selecting the long-term operation stop is not input to the controller and the water temperatures detected by both of the temperature sensors are lower than the specified threshold temperature, the controller opens the drain valves, thereby discharging water.

Since if a command instructive of selecting the long-term operation stop is not input to the controller and the water temperatures detected by both of the temperature sensors are lower than the specified threshold temperature, the controller opens the drain valves, thereby discharging water, water freezing in the fuel cell system can be prevented without fail even if the operator forgets to input a command instructive of selecting the long-term operation stop.

In the above fuel cell system, the controller further comprises a second mode selection command input unit for selecting a short-term stop of the power generation of the fuel cell. If a command instructive of selecting the short-term operation stop is input to the controller through the second mode selection command input unit and the water temperature detected by either of the temperature sensors is lower than the specified threshold temperature, the controller allows at least either circulation of the cooling water in the cooling water circulation passage or circulation of the hot water in the hot water circulation passage. If a command instructive of selecting the short-term operation stop is not input to the controller, the controller opens the drain valves to discharge water.

Since the controller further comprises the second mode selection command input unit used for selecting a short-term stop of the power generation of the fuel cell, and if a command instructive of selecting the short-term operation stop is input to the controller through the second mode selection command input unit and the water temperature detected by either of the temperature sensors is lower than the specified threshold temperature, the controller allows at least either circulation of the cooling water in the cooling water circulation passage or circulation of the hot water in the hot water circulation passage, whereas if a command instructive of selecting the short-term operation step is not input to the controller, the controller opens the drain valves to discharge water, water freezing in the fuel cell system can be properly prevented without fail according to the situation.

In the above fuel cell system, if a command instructive of selecting the short-term operation stop is input to the controller and the water temperatures detected by both of the temperature sensors are lower than the specified threshold temperature, the controller opens the drain valves to discharge water.

Since if a command instructive of selecting the short-term operation stop is input to the controller and the water temperatures detected by both of the temperature sensors are lower than the specified threshold temperature, the controller opens the drain valves to discharge water, water freezing in the fuel cell system at the time of the short-term operation stop can be effectively prevented without fail.

In the above fuel cell system, the controller further comprises a third mode selection command input unit for selecting a long-term stop or short-term stop of the power generation of the fuel cell. If a command instructive of selecting the long-term operation stop is input to the controller through the third mode selection command input unit, the controller opens the drain valves to discharge water, and if a command instructive of selecting the short-term operation stop is input to the controller and the water temperature detected by either of the temperature sensors is lower than the specified threshold temperature, the controller allows at least either circulation of the cooling water in the cooling water circulation passage or circulation of the hot water in the hot water circulation passage.

Since the controller further comprises the third mode selection command input unit for selecting the long-term stop or short-term stop of the power generation of the fuel cell, and if a command instructive of selecting the long-term operation stop is input to the controller through the third mode selection command input unit, the controller opens the drain valves to discharge water, whereas if a command instructive of selecting the short-term operation stop is input to the controller and the water temperature detected by either of the temperature sensors is lower than the specified threshold temperature, the controller allows at least either circulation of the cooling water in the cooling water circulation passage or circulation of the hot water in the hot water circulation passage, water freezing in the fuel cell system can be properly prevented without fail, depending on whether the long-term stop or short-term stop of the power generation of the fuel cell is selected.

In the fuel cell system, if a command instructive of selecting the short-term operation stop is input to the controller and the water temperatures detected by both of the temperature sensors are lower than the specified threshold temperature, the controller opens the drain valves to discharge water.

Since if a command instructive of selecting the short-term operation stop is input to the controller and the water temperatures detected by both of the temperature sensors are lower than the specified threshold temperature, the controller opens the drain valves to discharge water, water freezing in the fuel cell system during the short-term operation stop can be effectively prevented without fail.

### EFFECTS OF THE INVENTION

The invention has been implemented by the means described above so that a fuel cell system can be achieved, which is capable of readily, effectively preventing water freezing during a power generation suspension period without involving significant energy losses and troublesome monitoring and operation, while restricting a lack of maneuverability and which ensures safety and easy maintenance/upkeep of its operating functions.

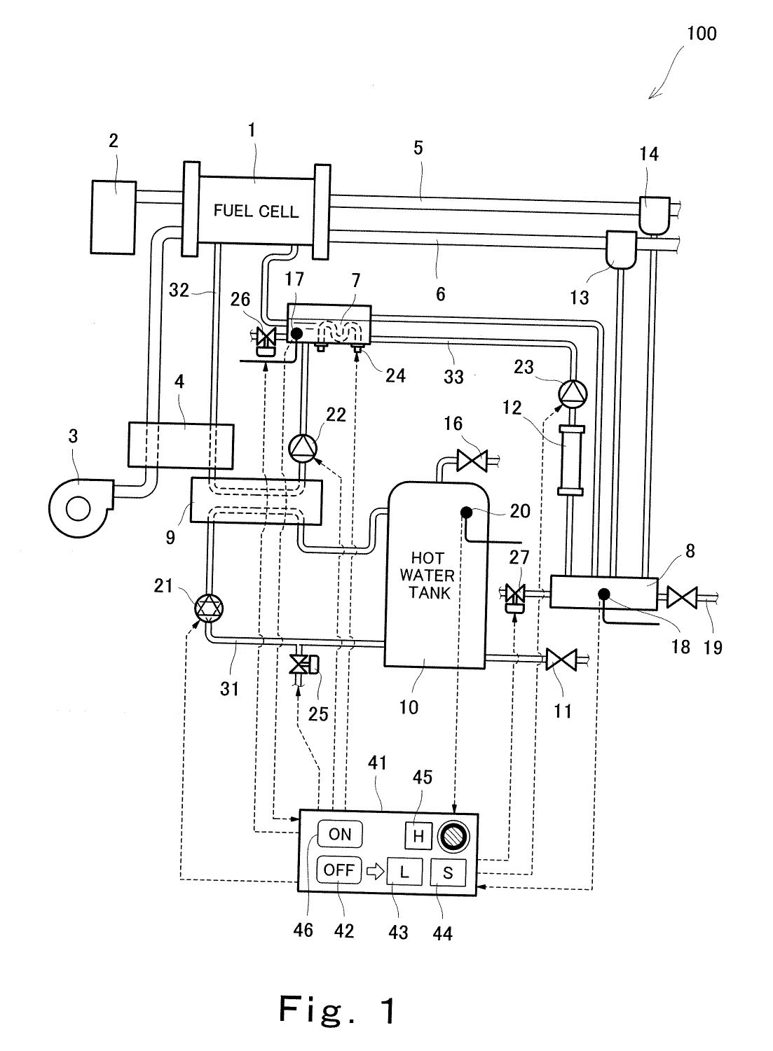

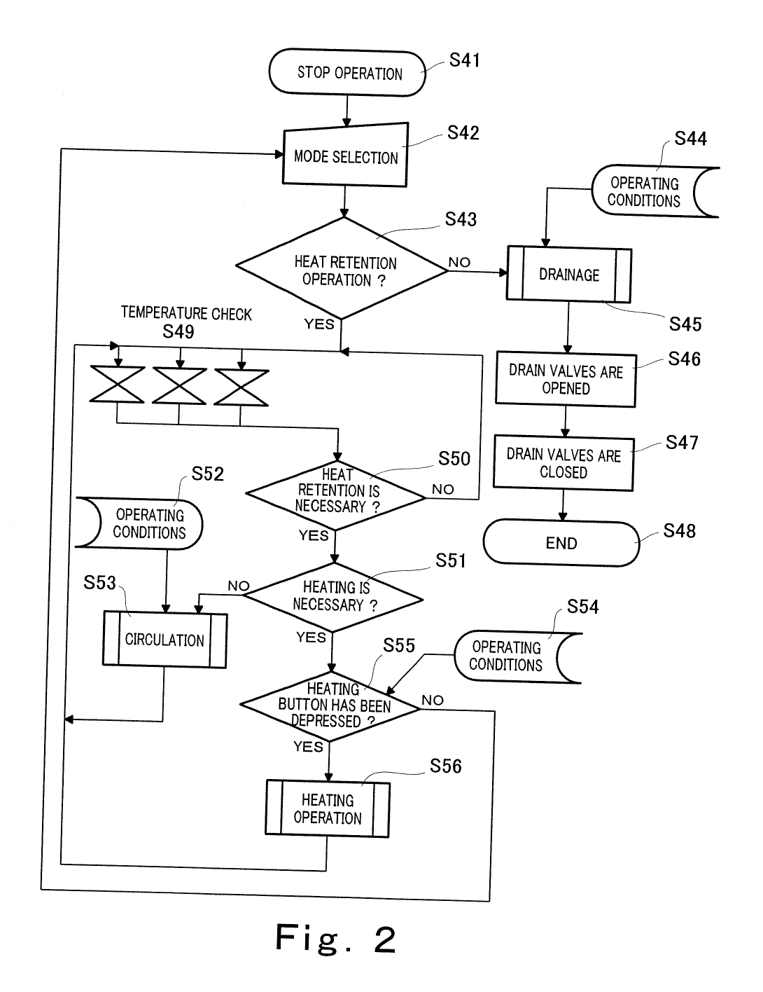

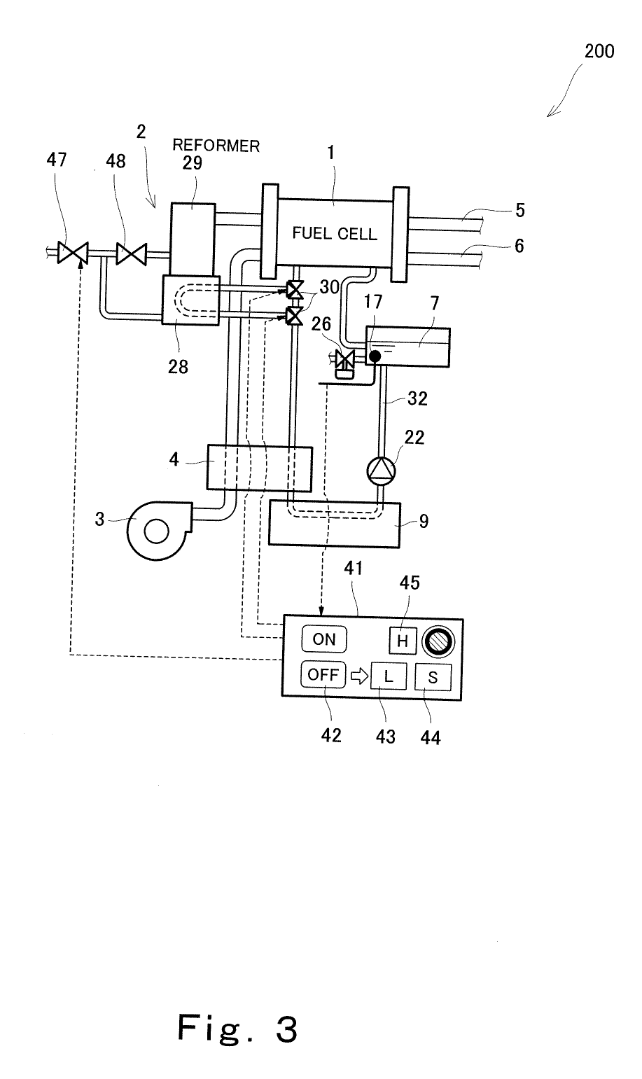

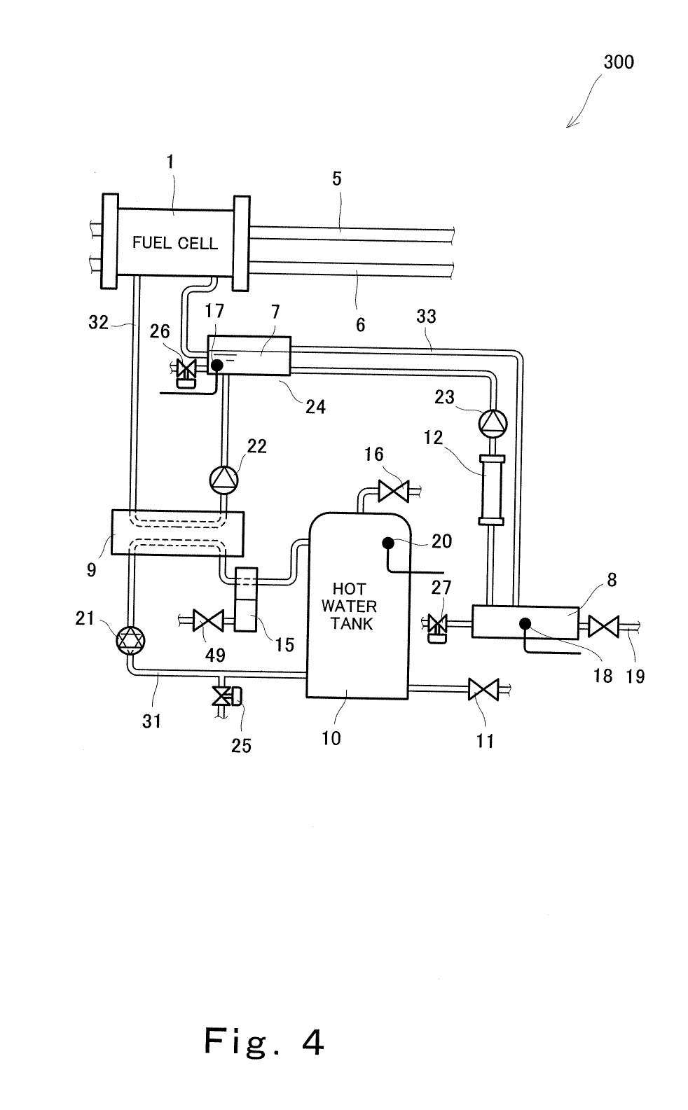

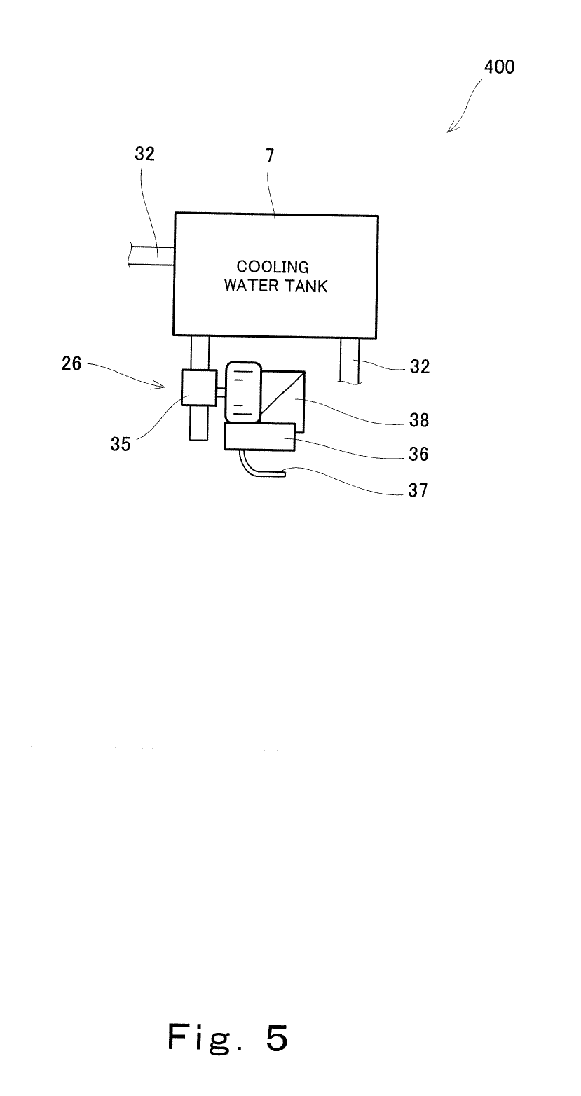

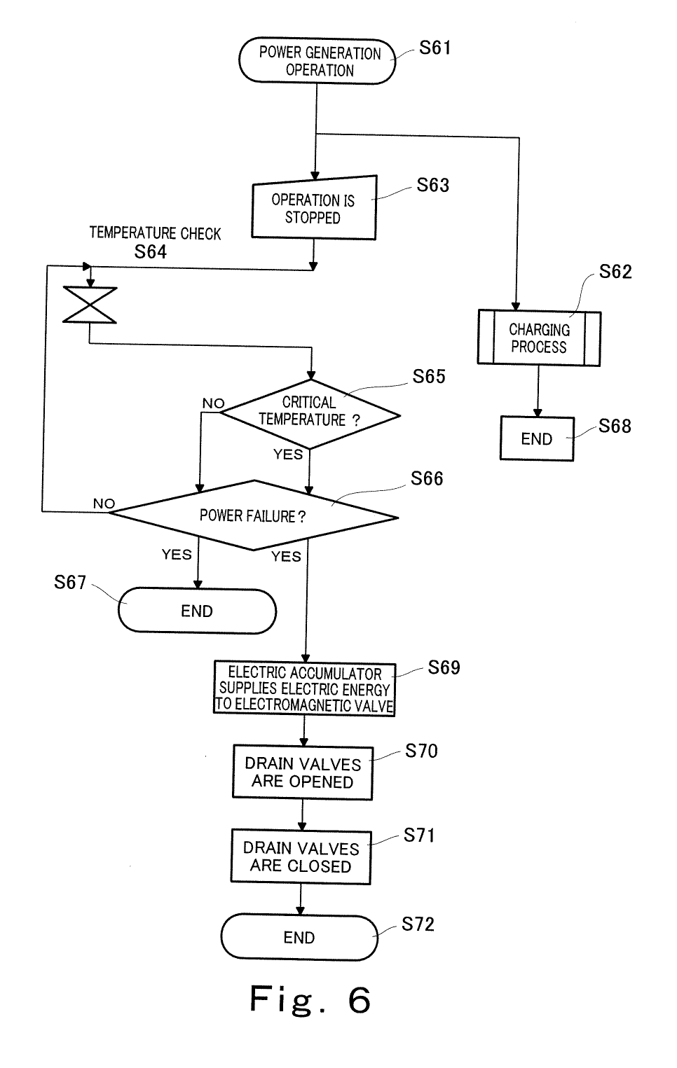

### BRIEF DESCRIPTION OF THE DRAWINGS

[FIG. 1] FIG. 1 is a structural view diagrammatically showing the configuration of an essential part of a fuel cell system according to a first embodiment of the invention.

[FIG. 2] FIG. 2 is a flow chart of the operation of the fuel cell system according to the first embodiment of the invention.

[FIG. 3] FIG. 3 is a structural view diagrammatically showing the configuration of an essential part of a fuel cell system according to a second embodiment of the invention.

[FIG. 4] FIG. 4 is a structural view diagrammatically showing the configuration of an essential part of a fuel cell system according to a third embodiment of the invention.

[FIG. 5] FIG. 5 is a structural view diagrammatically showing the configuration of an essential part of a fuel cell system according to a fourth embodiment of the invention.

[FIG. 6] FIG. 6 is a flow chart of the operation of the fuel cell system according to the fourth embodiment of the invention.

### EXPLANATION OF REFERENCE NUMERALS

1: fuel cell

2: fuel feeding device

3: oxidant feeding device

4: humidifier

5: remaining fuel discharging section

6: remaining oxidant discharging section

7: cooling water tank

8: feed water tank

9: heat recovery exchanger

10: hot water tank

11: feed water pipe

12: water purifier

13: remaining oxidant condenser

14: remaining fuel condenser

15: buck-up heater

16: hot water feeding port

17, 18, 20: temperature sensor

19: makeup feed pipe

21, 22, 23: water pump

24: heater

25, 26, 27: drain valve

28: burner

29: reformer

30: passage selector valve

31: hot water circulation passage

32: cooling water circulation passage

33: makeup water circulation passage

34: bypass passage

35: electromagnetic valve

36: electric accumulator

37: outside air temperature sensor

38: valve controller

41: controller

42: stop switch

43: long-term stop button

44: short-term stop button

45: heating button

46: starting switch

47, 48, 49: shut-off valve

100-400 fuel cell system

### BEST MODE FOR CARRYING OUT THE INVENTION

Referring now to the accompanying drawings, the best mode for carrying out the invention will be explained in detail.

In the embodiments of the invention, a thermocouple, thermistor or the like may be selected for use as a temperature sensor; a plunger pump, geared pump or the like may be selected for use as a water delivery device, depending on the rate of flow and the pressure required; a manually or electromagnetically operated shut-off valve may be selected for use as a switching device for a water circulation passage; and a seethe heater, electromagnetic induction heater, burner utilizing combustion heat or the like may be selected for use as a heater. These devices have been generally used for fuel cell systems and therefore a description of their constructions and operations is omitted herein.

Since the circuit configuration and operation generally employed in ordinary energy supplying systems are applicable to the driving control for the fuel cell system of the invention, a detailed explanation and illustration of them will be skipped in the following description.

### First Embodiment

FIG. 1 is a structural diagram diagrammatically showing the configuration of a fuel cell system constructed according to a first embodiment of the invention. It should be noted that FIG. 1 illustrates only the elements necessary for explaining the concept of the invention, while omitting unessential elements.

As illustrated in FIG. 1, the fuel cell system 100 of the first embodiment of the invention includes: a fuel cell 1 having a polymer ion exchange membrane as an electrolyte membrane; a fuel feeding device 2 for supplying a hydrogen-rich fuel gas to the fuel cell 1; an oxidant feeding device 3 for suctioning air from the atmosphere and supplying it under pressure to the fuel cell 1 as an oxidizing gas containing oxygen; a humidifier 4 for humidifying and heating the air fed from the oxidant feeding device 3 utilizing vapor before it is supplied to the fuel cell 1; and a cooling water tank 7 for storing cooling water to be circulated within the fuel cell 1. The cooling water tank 7 includes a heater 24 disposed therein for heating the cooling water.

As illustrated in FIG. 1, the fuel cell system 100 includes a remaining fuel discharging section 5 for discharging remaining fuel gas which has not been consumed in the fuel cell 1; and a remaining oxidant discharging section 6 for discharging remaining oxidizing gas which has not been consumed in the fuel cell 1. The fuel cell system 100 also includes a remaining fuel condenser 14 disposed at a specified position within the remaining fuel discharging section 5, for condensative separation of vapor from the remaining fuel gas. Further, the fuel cell system 100 includes a remaining oxidant condenser 13 disposed at a specified position in the remaining oxidant discharging section 6, for condensative separation of vapor from the remaining oxidizing gas. The water created through the condensative separation by the remaining oxidant condenser 13 and the remaining fuel condenser 14 is introduced into a feed water tank (described later) 8 after passing through a specified passage.

As illustrated in FIG. 1, the fuel cell system 100 has the feed water tank 8 for storing the water created through the condensative separation by the remaining oxidant condenser 13 and the remaining fuel condenser 14; and a water purifier 12 filled with an ion exchange resin for purifying the water stored in the feed water tank 8. The water stored in the feed water tank 8 is supplied to a cooling water tank 7 through a specified passage after purified by the water purifier 12. The cooling water, which has become redundant in the cooling water tank 7, overflows from the cooling water tank 7 and is stored in the feed water tank 8 again after passing through a specified passage. As illustrated in FIG. 1, a makeup feed pipe 19 is connected to the feed water tank 8, for supplying water from outside in case of shortage of water in the feed water tank 8.

As illustrated in FIG. 1, the fuel cell system 100 has a heat recovery exchanger 9 for recovering and exchanging heat which has been generated in the fuel cell 1 and carried by the cooling water; and a hot water tank 10 for storing hot water which has been increased in temperature by the heat recovery exchanger 9. That is, the fuel cell system 100 has a heat movement route configured so as to supply the heat generated in the fuel cell 1 to the hot water tank 10 through the heat recovery exchanger 9. It should be noted that a feed water pipe 11 is connected to the hot water tank 10, for supplying raw water to the hot water tank 10. Connected to the upper part of the hot water tank 10 is a hot water feeding port 16 used when the hot water stored in the hot water tank 10 is utilized.

As illustrated in FIG. 1, the fuel cell system 100 further includes temperature sensors 17, 18, 20 disposed at specified positions in the cooling water tank 7, feed water tank 8 and hot water tank 10, respectively. The temperature sensors 17, 18, 20 are for measuring the temperature of water stored in these tanks 7, 8, 10, respectively.

As illustrated in FIG. 1, the fuel cell system 100 includes: a cooling water circulation passage 32 for circulating the cooling water by way of the fuel cell 1, the humidifier 4, the heat recovery exchanger 9 and the cooling water tank 7; a hot water circulation passage 31 for circulating the hot water between the heat recovery exchanger 9 and the hot water tank 10; and a makeup water circulation passage 33 for circulating water between the cooling water tank 7 and the feed water tank 8. These passages are independent water circulation passages. Water pumps 21, 22, 23 for water circulation are disposed at specified positions in the hot water circulation passage 31, the cooling water circulation passage 32, and the makeup water circulation passage 33, respectively. A drain valve 25 is disposed at a specified position in the hot water circulation passage 31, for discharging the hot water. A drain valve 26 is disposed at a specified position in the cooling water tank 7, for discharging the cooling water. A drain valve 27 is disposed at a specified position in the feed water tank 8, for discharging the water.

As illustrated in FIG. 1, the fuel cell system 100 further includes a controller 41. The controller 41 consists of an arithmetic unit such as microcomputers and controls the operation of the fuel cell system 100 by controlling the desired elements thereof. It should be noted that the controller discussed herein means not only a single controller but also a group of controllers for executing control in cooperation with one another. Therefore, the controller 41 is not necessarily constituted by a single controller but may be constituted by a plurality of controllers which are disposed in discrete positions and formed so as to control the operation of the fuel cell system 100 in cooperation. For instance, the controller 41 may include a valve controller 38 described later.

As illustrated in FIG. 1, the controller 41 has a plurality of switches and buttons, as a means for inputting a command to the controller 41. More concretely, the controller 41 includes a stop switch 42 for stopping the operation of the fuel cell system 100; a starting switch 46 for start-up; a long-term stop button 43 and short-term stop button 44 that serve as an operating unit for selecting and determining stop conditions; and a heating button 45 for selecting and executing a heating operation if necessary during a suspension period.

The controller 41 properly controls the operations of the water pumps 21, 22, 23 and the heater 24 in response to output signals from the drain valves 25, 26, 27 and the temperature sensors 17, 18, 20. The controller 41 also properly controls the operations of other elements of the fuel cell system 100 according to need. As indicated by broken line of FIG. 1, the controller 41 is electrically interconnected to the temperature sensors 17, 18, 20, the drain valves 25, 26, 27 and the water pumps 21, 22, 23 and the heater 24 by means of a specified winding.

The relationship between the circulating pattern of water and the moving pattern of heat in the fuel cell system 100 of the first embodiment will be described in detail with reference to the drawings.

The fuel cell 1 shown in FIG. 1 generates heat simultaneously with power generation through the chemical reactions at the fuel electrode and the oxygen electrode. The heat generated in the fuel cell 1 is conveyed outwardly from the fuel cell 1 by means of the cooling water that is supplied from the feed water tank 8 to the cooling water tank 7 and circulated within the cooling water circulation passage 32 by actuating the water pump 22. That is, the fuel cell 1 discharges the cooling water that has risen in temperature, during power generation.

While passing through the humidifier 4, the cooling water, which has risen in temperature and has been discharged from the fuel cell 1, is partly used for humidifying and heating air supplied from the oxidant feeding device 3. The cooling water having high temperature, which has passed through the humidifier 4 without being used for the humidification/heating of the air in the humidifier 4, is used in the heat recovery exchanger 9, for heating water that flows in the hot water circulation passage 31. The cooling water, which has been cooled by heat exchange in the heat recovery exchanger 9, is stored again in the cooling water 7 and utilized again for cooling the fuel cell 1.

When the fuel cell system 100 starts up, the cooling water in the cooling tank 7 and the cooling water circulation passage 32 is heated and increased in temperature by applying electric power to the heater 24 disposed in the cooling water tank 7. Thus, the temperature increasing operation of the fuel cell 1 and the humidifier 4 is performed.

In the fuel cell system 100 of the first embodiment, the fuel cell 1 that generates heat during the power generation operation is thus cooled down by a series of heat conveyance in which the heat generated in the fuel cell 1 is conveyed to the humidifier 4 and the heat recovery exchanger 9 by the medium of the cooling water.

Actuation of the water pump 21 causes the water stored in the hot water tank 10 to pass through the hot water circulation passage 31 and then flow back to the hot water tank 10 by way of the heat recovery exchanger 9. At that time, the cooling water supplied through the feed water pipe 11 is drawn from the lower part of the hot water tank 10 and returns to the upper part of the hot water tank 10 after receiving heat and rising in temperature in the heat recovery exchanger 9. In this arrangement, since the hot water, which has been heated in the heat recovery exchanger 9, gradually accumulates from the upper part to lower part of the hot water tank 10, high-temperature hot water can be obtained through the hot water feeding port 16 provided at the upper part of the hot water tank 10, from the early stage of the power generation of the fuel cell system 100.

The water stored in the feed water tank 8 is purified through ion exchange in the water purifier 12 by actuating the water pump 23 according to need. Thereafter, the water is fed to the cooling water tank 7 through the makeup water circulation passage 33. If the water which has been condensed and separated by the remaining oxidant condenser 13 and the remaining fuel condenser 14 runs short and therefore the amount of water stored in the feed water tank 8 becomes short, the feed water tank 8 is replenished with water supplied from the outside of the fuel cell system 100 through the makeup feed pipe 19. After the volume of water in the feed water tank 8 is recovered, the water stored in the feed water tank 8 is supplied to the cooling water tank 7 through the makeup water circulation passage 33 according to need.

The water pump 23 is properly actuated when the cooling water in the humidifier 4 is consumed and the volume of water in the cooling water tank 7 decreases. If the volume of water stored in the cooling water tank 7 exceeds its normal level, the excessive cooling water overflows so as to return to the feed water tank 8. Thereby, the volume of water stored in the cooling water tank 7 is properly controlled.

In the cooling water tank 7 to which the cooling water circulation passage 32 and the makeup water circulation passage 33 are both connected, the cooling water supplied from the cooling water circulation passage 32 and the water supplied from the makeup water circulation passage 33 are mixed. That is, a heat exchange between the cooling water supplied from the cooling water circulation passage 32 and the water supplied from the makeup water circulation passage 33 is made in the cooling water tank 7. Since the cooling water tank 7 is replenished with water from the feed water tank 8 only when the volume of water in the cooling water tank 7 drops, the temperature of the water in the feed water tank 8 and the makeup water circulation passage 33 does not largely increase. Therefore, the ion exchange resin in the water purifier 12 is not damaged by heat.

Next, reference is made to explain the details of the operation that characterizes the invention, that is, the prevention of water freezing during a power generation suspension period in the fuel cell system 100.

FIG. 2 is a flow chart showing the operation of the fuel cell system according to the first embodiment of the invention.

For stopping power generation in the fuel cell system 100 of the first embodiment, the supply of the fuel gas from the fuel feeding device 2 to the fuel cell 1 and the supply of the oxidant gas from the oxidant gas feeding device 3 to the fuel cell 1 are stopped by depressing the stop switch 42 of the controller 41 shown in FIG. 1. Thereby, the chemical reaction that causes power generation in the fuel cell 1 is stopped, so that heat generation in the fuel cell 1 is stopped. The controller 41 confirms that the temperature of the cooling water in the cooling water tank 7 detected by the temperature sensor 17, the temperature of the water in the feed water tank 8 detected by the temperature sensor 18 and the temperature of the hot water in the hot water tank 10 detected by the temperature sensor 20 have respectively dropped below a specified temperature, subsequently to the stop of heat generation in the fuel cell 1. Then, the controller 41 stops the operations of the water pumps 21, 22, 23. Thereby, the movements of the hot water in the hot water circulation passage 31, the cooling water in the cooling water circulation passage 32 and the makeup water in the makeup water circulation passage 33 are stopped, so that the circulative movement of heat in the fuel cell system 100 is stopped.

After the heat generation in the fuel cell 1 have stopped together with the circulative movement of heat in the fuel cell system 100, the temperatures of the elements of the fuel cell system 100 begin to drop with time, following decreases in the temperature of the surrounding environment of the place where the fuel cell system 100 is installed. At that time, the temperature of the piping portion having relatively small heat capacity and relatively large exposed surface area drops relatively quickly, whereas the temperatures of elements having relatively high heat capacity such as the hot water tank 10 and the fuel cell 1 drop relatively slowly. Therefore, even if outside air temperature drops below a freezing point, it takes several hours or more before all the water in the fuel cell system 100 is frozen.

However, if water is frozen even in a part of the hot water circulation passage 31, the cooling water circulation passage 32, the makeup water circulation passage 33 etc., the water circulation is interrupted by the frozen water and therefore the fuel cell system 100 cannot normally start up again. In this case, use of some external means (e.g., means for melting the frozen water with hot air, hot water, etc.) becomes necessary to ensure the start-up performance of the fuel cell system 100 to property start it.

In addition, if water is frozen in any of the above circulation passages, the piping will be often broken by an expansion stress caused by the increased volume of the frozen water. In such a case, the fuel cell system 100 may become inoperative in a relatively early stage (e.g., 2 to 3 hours in some cases) after the power generation operation is stopped.

To avoid such a trouble, the first embodiment takes the following measure. As shown in FIG. 2, after the power generation operation of the fuel cell system 100 is stopped by depressing the stop switch 42 (Step S41), the user selectively depresses either the long-term stop button 43 or short-term stop button 44 of the controller 41 to determine whether the power generation stop operation is in a long-term operation stop mode or a short-term operation stop mode (Step S42). The long-term operation stop mode is such a mode that the fuel cell system 100 is brought into an asleep state to stop the power generation operation for a long period of time. The short-term operation stop mode is such a mode that the fuel cell system 100 is once brought into an OFF state for a short time and then into a wait state for restarting.

If the user selectively operates the long-term stop button 43 to bring the fuel cell system 100 into the asleep state, the controller 41 determines that a specified heat retention operation will not be performed (No at Step S43).

In this case, according to operating conditions preset in the memory of the controller 41 (Step S44), the controller 41 makes a shift to a drainage operation for discharging water from the fuel cell system 100 (Step S45). Then, the controller 41 outputs a specified command signal, thereby opening the drain valves 25, 26, 27 shown in FIG. 1 (Step S46). Thereby, the controller 41 completely discharges water from the hot water circulation passage 31, the cooling water circulation passage 32, the makeup water circulation passage 33, the cooling water tank 7, the feed water tank 8 and the hot water tank 10 to the outside of the fuel cell system 100.

After water has been completely discharged from the fuel cell system 100 and a specified process (e.g., time control, remaining water amount check control by a sensor, etc.) for checking whether the water discharge by the controller 41 has been finished has been completed, the controller 41 outputs a specified command signal, thereby closing the drain valves 25, 26, 27 (Step S47). By the operation performed at Step S47, the hot water circulation passage 31, the cooling water circulation passage 32, the makeup water circulation passage 33, the cooling water tank 7, the feed water tank 8 and the hot water tank 10 are respectively kept in a shut-up state so that undesirable drying can be prevented.

After confirming that the drain valves 25, 26, 27 have been completely brought into the closed state, the controller 41 stops the supply of electric power to the elements of the fuel cell system 100. The controller 41 completely stops the operation of the fuel cell system 100. Thereby, the fuel cell system 100 is brought into its asleep state during which the power generation operation is not performed for a long period of time (Step S48).

After the user has selectively depressed the short-term stop button 44 for bringing the fuel cell system 100 into the restart-wait state, the controller 41 determines to perform the specified heat retention operation (YES at Step S43).

In this case, the controller 41 checks the temperatures detected by the temperature sensors 17, 18, 20 which are provided for the cooling water tank 7, the feed water tank 8 and the hot water tank 10 respectively (Step S49). The controller 41 determines whether or not heat retention is necessary (Step S50).

More concretely, the controller 41 determines whether any of the temperatures detected by the temperature sensors 17, 18, 20 has become close to a water freezing temperature region (e.g., −3° C. to 0° C.). For instance, the controller 41 determines whether any of the temperature sensors has detected a temperature below a specified threshold temperature (e.g., 3° C.) which has been preset, based on the water freezing temperature region, taking account of the safety of the fuel cell system 100.

If any of the temperature sensors 17, 18, 20 has not detected a temperature below the specified threshold temperature, the controller 41 judges that the heat retention operation is unnecessary (NO at Step S50). Then, the controller 41 returns to Step S49 to repeatedly make a check until any of the temperatures detected by the temperature sensors 17, 18, 20 provided for the cooling water tank 7, the feed water tank 8 and the hot water tank 10 respectively becomes lower than the specified threshold temperature. Thus, Steps S49 and S50 are repeatedly effected in an adequate detection cycle.

If any of the temperature sensors 17, 18, 20 has detected a temperature below the specified threshold temperature, the controller 41 judges that the heat retention operation is necessary (YES at Step S50).

In this case, the controller 41 determines, based on the temperatures detected by the temperature sensors 17, 18, 20, whether it is necessary to heat the water stored in the cooling water tank 7, the feed water tank 8 or the hot water tank 10 which water is a heat source for the specified heat retention operation. If it is judged that water heating is unnecessary (NO at Step S51), the controller 41 executes water circulation as the specified heat retention operation, using the water present in the fuel cell system 100 as a source for the specified heat retention operation (Step S53).

Hereinafter, the water circulation at Step S53 will be described in detail.

As shown in FIG. 1, the fuel cell system 100 of the first embodiment has three water circulation passages, i.e., the hot water circulation passage 31, the cooling water circulation passage 32 and the makeup water circulation passage 33. Of the waters flowing in these water circulation passages, the water in the cooling water circulation passage 32, which flows back within the fuel cell 1, has the highest temperature during the normal power generation operation. The water in the makeup water circulation passage 33, which circulates overflowing between the cooling water tank 7 and the feed water tank 8, has relatively low temperature. The temperature of the water circulating in the hot water circulation passage 31 that communicates to the hot water tank 10 is relatively low at the initial stage of the power generation operation but gradually increases as the power generation operation proceeds. After a power generation period has elapsed and accumulation of high-temperature hot water has proceeded, the water circulating in the hot water circulation passage 31 accumulates and retains high heat capacity.

If the power generation operation of the fuel cell system 100 is stopped, the cooling water tank 7 and feed water tank 8 which are relatively low in reservoir capacity and heat capacity and the piping portion which has relatively large surface area exposed to the outside air decrease in temperature relatively quickly, whereas the elements having relatively high heat capacity such as the hot water tank 10 and the fuel cell 1 decrease in temperature relatively slowly.

In the fuel cell system 100 of the first embodiment, even if the temperature of the water stored in the cooling water tank 7 or the feed water tank 8 decreases below the threshold temperature (e.g., 3° C.), the hot water stored in the hot water tank 10 can be circulated in the hot water circulation passage 31 by actuating the water pump 21 through the controller 41, provided that the hot water stored in the hot water tank 10 has a temperature of 70° C. or more. In this case, the hot water having high temperature is pumped from the upper part of the hot water tank 10 so as to circulate in the hot water circulation passage 31, with the water supply direction of the water pump 21 being made opposite to the water supply direction when the normal power generation is performed. Thereby, the specified heat retention operation can be effectively performed in the fuel cell system 100.

At that time, the controller 41 actuates the water pump 22 at the same time with the actuation of the water pump 21, so that the cooling water stored in the cooling water tank 7 is allowed to circulate in the cooling water circulation passage 32. Thereby, a heat exchange between the cooling water circulating in the cooling water circulation passage 32 and the hot water circulating in the hot water circulation passage 31 is done in the heat recovery exchanger 9 so that the cooling water circulating in the cooling water circulation passage 32 rises in temperature. Accordingly, the temperature of the cooling water stored in the cooling water tank 7 can be made equal to or higher than the specified threshold temperature. That is, water freezing in the cooling water tank 7 and cooling water circulation passage 32 of the fuel cell system 100 can be prevented.

In addition, the controller 41 actuates the water pump 23 at the same time with the actuation of the water pumps 21, 22, thereby allowing the water stored in the feed water tank 8 to circulate between the makeup water circulation passage 33 and the cooling water tank 7. In the cooling water tank 7, the cooling water that has risen in temperature owing to the heat exchange in the heat recovery exchanger 9 is mixed with the water fed from the feed water tank 8, so that the water that has risen in temperature because of the mixing overflows and returns to the feed water tank 8 through the makeup water circulation passage 33. As a result, the temperature of the water stored in the feed water tank 8 can be made equal to or higher than the specified threshold temperature. That is, freezing of the water in the feed water tank 8 and makeup water circulation passage 33 in the fuel cell system 100 can be prevented.

The water circulation operation at Step S53 is an unheating-type heat retention operation applicable to cases where a water-freezable, low-temperature region arises in any parts of the fuel cell system 100. According to the water circulation operation at Step S53, since the water circulating in the hot water circulation passage 31, the cooling water circulation passage 32 and the makeup water circulation passage 33 partakes heat accumulated in and retained by the hot water tank 10, the water circulation is an effective means for preventing water freezing during a power generation suspension period, for instance, in the nighttime during which less hot water is used.

Whereas the first embodiment has been discussed in terms of a case where the temperatures of the waters stored in the cooling water tank 7 and the feed water tank 8 are below a specified threshold temperature and hot water having a temperature of 70° C. or more is stored in the hot water tank 10, various changes and modifications may be made to the water circulation operation at Step S53 and to the heat source used for preventing water freezing.

For instance, if the temperatures of the waters stored in the cooling water tank 7 and the feed water tank 8 are below the specified threshold temperature, the fuel cell 1 having high heat capacity and unsusceptible to temperature dropping may be used as the heat source for preventing water freezing, in place of the hot water tank 10. In this case, the controller 41 does not actuate the water pump 21 nor allow hot water circulation in the hot water circulation passage 31. Instead, the controller 41 actuates the water pump 22, thereby circulating cooling water in the cooling water circulation passage 32. This causes the cooling water heated in the fuel cell 1 to circulate in the cooling water circulation passage 32, so that freezing of the cooling water in the cooling water tank 7 and the cooling water circulation passage 32 can be prevented.

In addition, the controller 41 actuates the water pump 23 at that time, thereby causing water circulation in the makeup water circulation passage 33. Thereby, the cooling water that has risen in temperature is mixed with the water fed from the feed water tank 8 in the cooling water tank 7. The water which has risen in temperature because of the water mixing overflows, returning to the feed water tank 8 by way of the makeup water circulation passage 33, so that water freezing in the feed water tank 8 and the makeup water circulation passage 33 can be prevented.

In some cases, the hot water circulation in the hot water circulation passage 31 may be stopped, while making sole water circulation in either the cooling water circulation passage 32 or the makeup water circulation passage 33. Alternatively, water may be circulated in both of the cooling water circulation passage 32 and the makeup water circulation passage 33 at the same time, whereby the temperature of the cooling water tank 7, the feed water tank 8, the hot water tank 10 and the piping associated with them is raised by the heat retained by the feed water tank 8 and the fuel cell 1.

According to the first embodiment, at least any one of the fuel cell 1, the cooling water tank 7, the feed water tank 8, the hot water tank 10 etc. can be used as the heat source for preventing water freezing as far as it is in a condition usable as the heat source. In addition, water is circulated in at least any one of the hot water circulation passage 31, the cooling water circulation passage 32 and the makeup water circulation passage 33 with a suitable water circulation behavior selected according to the element to be used as the heat source, whereby water freezing in the fuel cell system 100 can be prevented.

Further, as shown in FIG. 2, the operating conditions for the water circulation operation at Step S53 are properly selected from predicted patterns and set (Step S52), and the water circulation operation is performed according to the selected/set operating conditions (Step S53), thereby preventing water freezing in the fuel cell system 100.

According to the invention, water freezing at a lower temperature portion of the fuel cell system 100 can be prevented without fail, only by the minimum operation, that is, actuation of the water pumps 21 to 23 etc. As a result, effective use of accumulated heat retained by the whole fuel cell system 100 becomes possible. It is obviously understood from FIG. 2 that while the water circulation operation being performed at Step S54, temperature check-ups at the specified positions are properly made by the temperature sensors 17, 18, 20 (Step S49) so that the condition of the fuel cell system 100 is properly judged (Step S49 to Step S53).

On the other hand, if the controller 41 judges based on the temperatures detected by the temperature sensors 17, 18, 20 that a heat source for preventing water freezing is not in the fuel cell system 100 at all, so it is necessary to heat water (YES at Step S51), water heating is then executed (Step S56).

For instance, if the controller 41 judges that the temperature of the cooling water in the cooling water tank 7 detected by the temperature sensor 17 is 0.5° C. which is lower than a threshold temperature (1° C.) and if it is confirmed that the user has depressed the heating button 45 of the controller 41 (YES at Step S55), a specified amount of electric power is supplied to the heater 24 disposed in the cooling water tank 7, thereby heating the cooling water of the cooling water tank 7 until it reaches 1° C. At that time, it is unnecessary to supply electric power to the heater 24 to make the temperature of the cooling water significantly high. In other words, it is enough to supply electric power to the heater 24 until the temperature of the cooling water reaches such a value that water freezing is preventable. In addition, while a check-up of the temperature of the cooling water (Step S49) being made by the temperature sensor 17 (Steps S49 to S51 and Step S56), the supply of electric power to the heater 24 is appropriately controlled by the controller 41.

It should be noted that the threshold value (e.g., 1° C.) used at Step S51 for determining whether or not water heating is needed may be the same as or differ from the specified threshold temperature used at Step S50. In this case, the threshold temperature used at Step S51 may be set to a temperature lower than the specified threshold temperature used at Step 50 like the instance described earlier, whereby the amount of electric power to be supplied to the heater 24 can be restricted to perform the control with a further reduced amount of energy.

After confirming that the temperature of the cooling water in the cooling water tank 7 detected by the temperature sensor 17 has reached the value (1° C.) equal to the threshold temperature, the controller 41 causes the cooling water to circulate in the cooling water circulation passage 32, using the cooling water tank 7 as the heat source for the specified heat retention operation so that water circulation is executed as the specified heat retention operation (Step S53).

On the other hand, if it is determined as described earlier that water heating is necessary (YES at Step S51) and the heating button 45 has not been depressed, the controller 41 returns to Step S42 to execute the mode selection without executing the water heating operation of Step S56 and the water circulation operation of Step S53 (NO at Step S55), and the control operation may be manually or automatically shifted to the long-term stop mode (NO at Step S43) for bringing the fuel cell system 100 into the asleep state. Herein, a detailed description of the control operation is skipped because it is a known technique. However, if the temperature of the cooling water in the cooling water tank 7 is below the threshold temperature (e.g., 1° C.) that is lower than the specified threshold temperature (e.g., 3° C.), the controller 41 returns to Step S42 without executing the water heating operation (Step S56) and the water circulation operation (Step S53) to select the operation of the long-term operation stop mode for bringing the fuel cell system 100 into the asleep state.

As shown in FIG. 2, if the specified heat retention operation is determined to be necessary (YES at Step S50), water heating is determined to be unnecessary (NO at Step S51), and after execution of the water circulation operation at Step S53, water heating is determined to be necessary (YES at Step S51) based on the temperature check at Step S49, the controller 41 can return to Step S42 to execute the mode selection and make a shift to the long-term operation stop mode for bringing the fuel cell system 100 into the asleep state (NO at Step S43). Such control can be selected according to need by the user not depressing the heating button 45 provided in the controller 41. In this case, the controller 41 enters the long-term operation stop mode according to the operating conditions preset (Step S54) in the memory of the controller 41.

With the above control operation, the specified heat retention operation can be executed without supplying electric power to the heater 24 only when the fuel cell system 100 has spare accumulated heat. As a result, water freezing can be prevented during the power generation suspension period without consuming a large amount of energy.

Although the mode selection step S42 is provided as shown in FIG. 2 in this embodiment, this mode selection step is not essential. Instead of the mode selection, a single-mode control system may be employed. According to this system, after the power generation operation of the fuel cell system 100 is stopped at Step S41, if the controller 41 judges according to the temperatures detected by the temperature sensors 17, 18, 20 that the waters stored in the cooling water tank 7, the feed water tank 8 and the hot water tank 10 need to be respectively heated, the water discharge control is automatically executed at Steps S44 to S48. With such a system, water freezing can be prevented during the power generation suspension period, without consuming a large amount of energy.

Although the first embodiment has been discussed in terms of a case where the controller 41 includes both the long-term stop button 43 and the short-term stop button 44, the invention is not necessarily limited to this but may be applied to cases where the controller 41 includes either the long-term stop button 43 or the short-term stop button 44.

For instance, where the controller 41 has only the long-term stop button 43, if the user has depressed the long-term stop button 43, the controller 41 then opens the drain valves 25, 26, 27 to discharge water from the hot water tank 10, the cooling water tank 7 and the feed water tank 8. On the other hand, if the user has not depressed the long-term stop button 43 and any of the temperatures detected by the temperature sensors 17, 18, 20 is below the specified threshold temperature, the controller 41 causes water circulation at least in any of the hot water circulation passage 31, the cooling water circulation passage 32 and the makeup water circulation passage 33. If all the temperatures detected by the temperature sensors 17, 18, 20 are below the specified threshold temperature, the controller 41 opens the drain valves 25, 26, 27 to discharge water from the hot water tank 10, the cooling water tank 7 and the feed water tank 8.

In cases where the controller 41 has only the short-term stop button 44, if the user has depressed the short-term stop button 44 and any of the temperatures detected by the temperature sensors 17, 18, 20 is below the specified threshold temperature, the controller 41 causes water circulation at least in any of the hot water circulation passage 31, the cooling water circulation passage 32 and the makeup water circulation passage 33. If all the temperatures detected by the temperature sensors 17, 18, 20 are below the specified threshold temperature, the controller 41 opens the drain valves 25, 26, 27 to discharge water from the hot water tank 10, the cooling water tank 7 and the feed water tank 8. On the other hand, if the user has not depressed the short-term stop button 44, the controller 41 opens the drain valves 25, 26, 27 to discharge water from the hot water tank 10, the cooling water tank 7 and the feed water tank 8.

In the above-described modified cases, the same effect as of the first embodiment can be attained.

In the fuel cell system 100 of the first embodiment, after stopping the power generation operation, the controller 41 executes the short-term operation stop mode or the long-term operation stop mode in response to the operation of the short-term stop button 44 or the long-term stop button 43. In the short-term operation stop mode, single water circulation or plural simultaneous water circulations are made in the hot water circulation passage 31, the cooling water circulation passage 32 and/or the makeup water circulation passage 33, depending on the temperatures detected by the temperature sensors 17, 18, 20. In the long-term operation stop mode, the drain valves 25, 26, 27 are opened to discharge water. This enables economical easy heat retention operation for preventing water freezing by making effective use of the heat energy unevenly distributed within the fuel cell system.

In the fuel cell system 100 of the first embodiment, all the water existing therein is outwardly discharged when the heat energy unevenly distributed in the fuel cell system has been used up or when the fuel cell system 100 is brought into its long-term asleep state. Thereby, the fuel cell system does not require a supply of a huge amount of energy for preventing water freezing and ensures economical maintenance/upkeep.

According to the fuel cell system 100 of the first embodiment, if the short-term operation stop mode which makes a quick restart after a short-term suspension is selected and the heat energy stored in the system 100 for the specified heat retention runs short, water is heated and circulated with a minimum necessary amount of energy generated by the heater etc. This enables the fuel cell system to prevent water freezing without fail, while being maintained in the restart-wait state from which the operation of the system can be easily restarted.

According to the fuel cell system 100 of the first embodiment, after stopping the power generation operation, easy operation control is performed in which only whether a long-term stop or short-term stop of the fuel cell system 100 is selected, whereby economical maintenance/upkeep is enabled and the ability of meeting energy demands as an energy supply system can be optimally ensured. In addition, the fuel cell system 100 has such characteristics that can flexibly cope with various situations by properly judging required conditions irrespective of the condition of internal temperature that varies depending on the contents of the operation performed before stopping the power generation operation and can ensure easy restarting as well as safety while restricting energy losses.

### Second Embodiment

A second embodiment is associated with a fuel cell system having a reformer and heater as a fuel feeding device and the heat generated by the heater is utilized for preventing water freezing.

FIG. 3 is a structural view diagrammatically showing the configuration of the fuel cell system of the second embodiment of the invention. In FIG. 3, only the elements necessary for explaining the concept of the invention are illustrated, while unessential elements and the elements that function similarly to those of the first embodiment are omitted.

In FIG. 3, the parts that correspond to those of the first embodiment are indicated by the same reference numerals as in FIG. 1.

As illustrated in FIG. 3, the fuel cell system 200 according to the second embodiment of the invention includes, as the fuel feeding device 2, a reformer 29 and a burner 28 for heating the reformer 29 to a temperature suitable for catalytic reforming and keeping it at this temperature. The reformer 29 generates a reformed gas from a material with the aid of a reforming catalyst for catalytic reforming, the material containing an organic compound composed of at least carbon and hydrogen. Examples of the material include city gas, methane, natural gas and methanol. It should be noted that the above material is supplied to both the burner 28 and the reformer 29 during the power generation operation of the fuel cell system 200.

As illustrated in FIG. 3, the fuel cell system 200 has a pair of passage selector valves 30 that are disposed between the fuel cell 1 and the humidifier 4 within the cooling water circulation passage 32 in which cooling water is circulated by the operation of the water pump 22 so as to pass through the cooling water tank 7, the fuel cell 1, the humidifier 4 and the heat recovery exchanger 9. These passage selector valves 30 each consist of a three-way valve.

As illustrated in FIG. 3, the fuel cell system 200 has a bypass passage 34 that connects the passage selector valves 30 to each other, passing therethrough. The bypass passage 34 has a U-shaped turning portion (located on the left side in FIG. 3) that is located within the burner 28.

Specifically, the fuel cell system 200 of the second embodiment is constructed such that the bypass passage 34 is inserted in the middle of the cooling water circulation passage 32 by properly manipulating the passage selector valves 30. Thereby, the cooling water, which circulates in the cooling water circulation passage 32, passing through the cooling water tank 7, the fuel cell 1, the humidifier 4 and the heat recovery exchanger 9, is allowed to circulate in the cooling water circulation passage 32 and the bypass passage 34 so as to pass through the cooling water tank 7, the fuel cell 1, the burner 28, the humidifier 4 and the heat recovery exchanger 9.

As shown in FIG. 3, the fuel cell system 200 has a shut-off valve 47 for controlling the supply and shut-off of the material to and from the reformer 29 and the burner 28. The fuel cell system 200 further has a shut-off valve 48 for controlling the supply and shut-off of the material to and from the reformer 29.

It should be noted that other elements of the fuel cell system 200 do not differ from their corresponding elements of the fuel cell system 100 of the first embodiment.

In the fuel cell system 200 of the second embodiment, when stopping the power generation operation, the stop switch 42 provided in the controller 41 is depressed so that the shut-off valve 48 is shifted from its open state to its closed state, thereby stopping the supply of the material to the reformer 29. Then, the generation of the reformed gas in the reformer 29 and therefore the supply of the reformed gas to the fuel cell 1 stop, so that the electric power generation and heat generation in the fuel cell 1 stop. If such a stop state continues, the elements of the fuel cell system 200 decrease in temperature owing to the dissipation of heat to the atmosphere similarly to the case of the fuel cell system 100 of the first embodiment, with the result that the temperature of the water in the cooling water circulation passage 32 approaches to the water freezing temperature region.

In the second embodiment, after the controller 41 judges that the temperature of the cooling water detected by the temperature sensor 17 drops to a value equal to or lower than a preset threshold temperature (e.g., 3° C.), the passage selector valves 30 operate in response to an instruction from the controller 41 provided that the short-term stop button 44 and the heating button 45 have been depressed, so that the bypass passage 34 is inserted in the middle of the cooling water circulation passage 32. Thereby, the cooling water circulates in the cooling water circulation passage 32, taking the devious route, i.e., the bypass passage 34.

At the same time, the controller 41 opens the shut-off valve 47 so that the burner 28 is supplied with the material. Thereby, the burner 28 starts combustion of the material to generate heat.

Then, the cooling water forcibly circulated in the cooling water circulation passage 32 by the operation of the water pump 22 is heated with the heat generated by the burner 28 and rises in temperature. That is, in the second embodiment, the burner 28 of the fuel feeding device 2 is used as a heat source for preventing water freezing, in place of the fuel cell 1, the hot water tank 10 etc. Similarly to the fuel cell system 100 of the first embodiment, the heat of the cooling water which has risen in temperature is transferred to other water circulation passages by way of the cooling water tank 7 and the heat recovery exchanger 9. Thereby, water freezing in the fuel cell system 200 is prevented.

In the second embodiment, the supply and shut-off of the material to and from the burner 28 and the supplying amount of the material are properly controlled by the controller 41 according to the temperature of the cooling water detected by the temperature sensor 17 such that the temperature of the cooling water circulating in the cooling water circulation passage 32 does not excessively increase. As a result, a sufficient amount of heat energy for preventing water freezing can be obtained in the fuel cell system 200 of the second embodiment.

Although the second embodiment has been discussed with the bypass passage 34 that is made insertable by the passage selector valves 30 provided for the cooling water circulation passage 32, the invention is not necessarily limited to this but may be equally applicable to cases where the bypass passage 34 is made insertable by providing the hot water circulation passage 31 or the makeup water circulation passage 33 with the passage selector valves 30. However, it should be noted that the provision of the passage selector valves 30 in the cooling water circulation passage 32 is the most desirable because the temperature rise of the reformer 29 due to the combustion of the material by the burner 28 occurs concurrently with the temperature rise of the fuel cell 1 in the preheating state before the power generation operation of the fuel cell system 200 starts. On the other hand, the cases where the bypass passage 34 is made insertable by providing the makeup water circulation passage 33 with the passage selector valves 30 is undesirable for the reason that the heat of the water which has risen in temperature is likely to significantly deteriorate the function of the ion exchange resin provided in the water purifier 12.

The amount of energy necessary for continuously preventing water freezing is normally within the range of from several watts/min. to several tens of watts/min., although it varies more or less, depending upon the ambient temperature of the place where the fuel cell system 200 is installed and upon the heat retention structure etc. of the area of the fuel cell system 200 where water exists. In the fuel cell system 200, there is no need to continuously supply a regular amount of energy to the cooling water. For instance, the supply of energy to the cooling water can be intermittently done in the fuel cell system 200 in such a way that the cooling water stored in the cooling water tank 7 is heated by the burner 28, utilizing its heat capacity (heat-retaining property) until its temperature reaches a specified value, and thereafter, the combustion in the burner 28 is stopped until the temperature of the cooling water drops to the water freezing temperature region. In this way, the need for the ultra low volume combustion by the burner 28 is eliminated, so that water freezing in the fuel cell system can be prevented using the reformer 29 of the normal specification.

According to the fuel cell system 200 of the second embodiment, water freezing can be easily prevented in a simple manner only by utilizing the burner 28 as a heat source which burner 28 is an essential element for the production of reformed gas from the material by the reformer 29 and by providing the cooling water circulation passage 32 with the passage selector valves 30.

### Third Embodiment

A third embodiment of the invention is associated with an instance where water freezing is prevented by making use of heat generated by a back-up heater that is provided in an ordinary fuel cell system for maintaining the temperature of hot water stored in the hot water tank.

FIG. 4 is a structural view diagrammatically showing the configuration of a fuel cell system according to the third embodiment of the invention. In FIG. 4, only the elements necessary for explaining the concept of the invention are illustrated, while unessential elements and the elements that function similarly to those of the first and second embodiments are omitted.

In FIG. 4, the parts that correspond to those of the first embodiment are indicated by the same reference numerals as in FIG. 1.

As illustrated in FIG. 4, the fuel cell system 300 of the third embodiment of the invention has a back-up heater 15 disposed at a specified position in the hot water circulation passage 31, for keeping the hot water stored in the hot water tank 10 at a specified temperature. Specifically, in the third embodiment, the back-up heater 15 is located at a specified position in the area where the hot water flows from the upper part of the hot water tank 10 to the heat recovery exchanger 9 within the hot water circulation passage 31, in order to supply the hot water of high temperature to the heat recovery exchanger 9 (or in order to effectively supply the heat of the hot water to the heat recovery exchanger 9). In the third embodiment, the back-up heater 15 combusts city gas or the like supplied through a shut-off valve 49 (see FIG. 4) and heats the hot water with the heat generated by the combustion.

Similarly to the prior art fuel cell system, the fuel cell system 300 of the third embodiment is such that if the high-temperature hot water stored in the hot water tank 10 runs short, the back-up heater 15 is operated concomitantly even if the fuel cell 1 is in its power generating state so that a required amount of hot water can be supplied from the hot water feeding port 16. In this case, the hot water stored in the hot water tank 10 is circulated by the water pump 21 so as to pass through the water pump 21, the heat recovery exchanger 9, the back-up heater 15 and the hot water tank 10 in this order.

Similarly to the fuel cell system 100 of the first embodiment, when executing the specified heat retention operation, the water pump 21 is controlled so as to feed water in a direction opposite to the water feeding direction when the power generation operation is normally performed. The water pump 21 pumps out the hot water so that it circulates between the heat recovery exchanger 9 and the hot water tank 10, and more specifically such that it comes out from the upper part of the hot water tank 10 and returns to the lower part of the hot water tank 10 by way of the heat recovery exchanger 9. As illustrated in FIG. 4, the back-up heater 15 is disposed at the specified position within the hot water circulation passage 31. With this arrangement, the hot water flowing in the hot water circulation passage 31 is heated by the back-up heater 15 and therefore the temperature of the hot water stored in the hot water tank 10 is controlled.

Other elements constituting the fuel cell system 300 do not differ from their corresponding elements of the fuel cell system 100 of the first embodiment.

In the fuel cell system 300 of the third embodiment, if the controller 41 judged that the temperature of the cooling water detected by the temperature sensor 17 has dropped to a value equal to or lower than the preset threshold temperature (e.g., 3° C.), the water pump 21 is then actuated in response to an instruction from the controller 41 so that water circulates within the hot water circulation passage 31.

At the same time, the shut-off valve 49 is opened by the controller 41, thereby feeding city gas or the like to the back-up heater 15. Thereby, the back-up heater 15 starts combustion using the city gas to start heat generation.

The temperature of the water forcibly circulated within the hot water circulation passage 31 by the operation of the water pump 21 rises as the water is heated by the heat generated by the back-up heater 15. In short, according to the third embodiment, the back-up heater 15 is utilized as the heat source for preventing water freezing, instead of the fuel cell 1, the burner 28, etc. Similarly to the fuel cell system 100 of the first embodiment, the heat of the hot water which has risen in temperature is transmitted to other water circulation passages (in this case, the cooling water circulation passage 32) through the heat recovery exchanger 9. If the controller 41 judges that the temperature of the water detected by the temperature sensor 18 has dropped to a value equal to or lower than the specified threshold temperature (e.g., 3° C.), the heat of the hot water which has risen in temperature is transmitted to the makeup water circulation passage 33 through the heat recovery exchanger 9 and the cooling water tank 7. Thereby, water freezing in the fuel cell system 300 can be prevented.

Although the third embodiment has been discussed in terms of a case where the back-up heater 15 generates heat through combustion of city gas etc., the invention is not necessarily limited to this but is equally applicable to cases where the back-up heater 15 consists of a heater of other types such as electric heaters.

According to the fuel cell system 300 of the third embodiment, water freezing in the system 300 can be prevented without fail in a simple way not by newly employing a special device but by making use of the existing element of the fuel cell system 300 as a heat source.

### Fourth Embodiment

The fourth embodiment of the invention is characterized by the structure of the drain valves 25, 26, 27 disposed in the hot water circulation passage 31, the cooling water tank 7 and the feed water tank 8 respectively and the operation of a fuel cell system having these elements.

FIG. 5 is a structural view diagrammatically showing the configuration of the drain valves in the fuel cell system and their peripheral parts according to the fourth embodiment of the invention. In FIG. 5, only the elements necessary for explaining the concept of the invention are illustrated, while unessential elements and the elements that function similarly to those of the first to third embodiments are omitted.

In FIG. 5, the parts that correspond to those of the first embodiment are indicated by the same reference numerals as in FIG. 1.

Of the drain valves 25, 26, 27, only the structure of the drain valve 26 and its peripheral parts is illustrated in FIG. 5.

As illustrated in FIG. 5, the fuel cell system 400 of the fourth embodiment has the drain valve 26 in the neighborhood of the bottom part of the cooling water tank 7, similarly to the fuel cell system 100 of the first embodiment. In the fourth embodiment, the drain valve 26 includes: a normally-closed type electromagnetic valve 35 that is open only when current is applied thereto; an electric accumulator 36 that accumulates and stores electric energy supplied for bringing the electromagnetic valve 35 into its open state when the electric terminal of the electromagnetic valve 35 is electrically connected to the electric terminal of the electric accumulator 36; an outside air temperature sensor 37 for detecting the temperature of the outside air around the fuel cell system 400; and the valve controller 38 for controlling the operations of these elements in conjunction with one another. In the fourth embodiment, a capacitor is used as the electric accumulator 36. Although the drain valves 25, 27 are not particularly shown in FIG. 5, each of them has the same structure as of the drain valve 26 shown in FIG. 5.

Other elements that constitute the fuel cell system 400 do not differ from their corresponding parts of the fuel cell system 100 of the first embodiment.

Next, the drain valves 25, 26, 27 of the fuel cell system 400 that characterize the invention will be described in detail with reference to the drawings.

FIG. 6 is a flow chart showing the operation of the fuel cell system according to the fourth embodiment of the invention.

As shown in FIG. 6, in the fuel cell system 400 of the fourth embodiment, while the power generation operation is performed (Step S61), the valve controller 38 shown in FIG. 5 controls the electric accumulator 36 so as to perform charging operation to accumulatively store electric energy therein (Steps S62, S68). Thereby, the drain valve 26 can be brought into its open state whenever the electric accumulator 36 supplies electric energy to the electromagnetic valve 35.

If the stop button 42 (shown in FIG. 1) of the controller 41 is depressed to stop the power generation operation of the fuel cell system 400 (Step S63) and the short-term stop button 44 of the controller 41 is selectively depressed to select the mode of the specified heat retention operation, the temperature of the outside air is detected by the outside air temperature sensor 37 of the drain valve 26 (Step S64), while leaving the system 400 at rest and performing the heat retention. The controller 41 judges whether the outside air temperature is equal to or lower than the preset threshold temperature (e.g., 3° C.) that is close to the water freezing temperature region, thereby determining whether there is a risk that water freezing may occur in the fuel cell system 400 if it is left unattended (Step S65).

If the result of the determination at Step S65 is that there is a risk (YES at Step S65), or that there is no risk (NO at Step S65), the controller 41 proceeds to the next step for making a check to determine whether power failure has occurred (Step S66).

If the controller 41 judges that power failure has not occurred (NO at Step S66), the controller 41 returns to Step S64 to recheck the temperature of the outside air. If the controller 41 judges that power failure has occurred (YES at Step S66), the controller 41 then executes specified control based on the result of the determination at Step 65.

More concretely, if the controller 41 judge, as shown in FIG. 6, that there is no risk of water freezing at Step S65 (NO at Step S65) and that power failure has occurred (YES at Step S66), the controller 41 stops all the operations associated with the fuel cell system 400 (Step S67). If the controller 41 judges that there is a risk of water freezing at Step S65 (YES at Step S65) and that power failure has occurred (YES at Step S66), the controller 41 allows the electric accumulator 36 to supply electric energy to the electromagnetic valve 35 (Step S69), thereby opening the drain valve 26 (Step S70). In this way, the drainage of water through the drain valve 26 (and the drain valves 25, 27) is executed so that all the water existing within the fuel cell system 400 is discharged outwardly therefrom. Since all the energy retained by the electric accumulator 36 is supplied to the electromagnetic valve 35 and the electromagnetic valve 35 is automatically closed upon completion of the electric discharge of the electric accumulator 36, the drain valve 26 is shifted from its open state to its closed state (Step S71). The controller 41 stops all the operations associated with the fuel cell system 400 (Step S72).

Water temperature may drop after completion of the processing although it does not reach the threshold temperature at the time of power failure. This case can be dealt with without causing a problem, because spare time is provided for manual temperature detection and troubleshooting. While a capacitor is used as the electric accumulator 36 in the fourth embodiment, it is readily apparent that any other devices for accumulating electric energy such as storage batteries may be used as the electric accumulator 36.

According to the fuel cell system 400 of the fourth embodiment, in the event of power failure, the fuel cell system is brought to a stop after discharging water by the drain valve operation back-up function of the valve controller 38 if there is a risk of water freezing, so that the fuel cell system can be protected. In the event of emergency, the fuel cell system is also prevented from being damaged.

According to the fuel cell system 400 of the fourth embodiment, since the electromagnetic valve 35 automatically returns to its stationary state (i.e., closed state) after completion of the electric discharge of the electric accumulator 36, the fuel cell 1 vulnerable to drying can be kept in a specified favorable condition without deterioration.

### INDUSTRIAL APPLICABILITY

The fuel cell system of the invention is industrially applicable as a fuel cell system capable of maintaining and ensuring safe power generation operation by preventing damage caused by water freezing without fail while restraining energy losses, troublesome operations and a lack of mobility.

The fuel cell system of the invention is industrially applicable as a cogeneration system for household or industrial use capable of making effective use of both electric power and heat generated through power generation.

The fuel cell system of the invention is industrially applicable as a fuel cell system for use in electric vehicles that require electricity as a power source and in movable work machines such as cargo-handling carrier machines.

1-14. (canceled)

15. A method of operating a fuel cell system comprising:
step (a) of selecting a long-term operation stop of a power generation operation of the fuel cell system;
step (b) including step (b-1) of discharging water from at least one of a cooling water circulating passage for circulating cooling water for cooling a fuel cell and a cooling water tank for storing the cooling water, after the step (a), and step (b-2) of discharging water from at least one of a hot water circulating passage for circulating hot water which exchanges heat with the cooling water and a hot water tank for storing the hot water, after the step (a);
step (c) including step (c-1) of detecting a water temperature in at least one of the cooling water circulating passage and the cooling water tank, and step (c-2) of detecting a water temperature in at least one of the hot water circulating passage and the hot water tank; and
step (d) of operating at least one pump selected from a group consisting of a first water pump provided in the cooling water circulating passage and a second water pump provided in the hot water circulating passage, if the step (a) is not performed and if one of the water temperatures detected in the step (c) is lower than a specified threshold temperature, during suspension of a power generation operation of the fuel cell system.

16. The method according to claim 15, further comprising:
step (e) including step (e-1) of discharging water from at least one of the cooling water circulating passage and the cooling water tank and step (e-2) of discharging water from at least one of the hot water circulating passage and the hot water tank, if the step (a) is not performed and if both of the water temperatures detected in the step (c) are lower than the specified threshold temperature during the suspension of the power generation operation of the fuel cell system.

17. The method according to claim 15, further comprising:
step (e) including step (e-1) of discharging water from at least one of the cooling water circulating passage and the cooling water tank and step (e-2) of discharging water from at least one of the hot water circulating passage and the hot water tank, if the step (a) is not performed, and if both of the water temperatures detected in the step (c) are lower than a set temperature lower than the specified threshold temperature during the suspension of the power generation operation of the fuel cell system.

18. The method according to claim 15,
wherein the step (b) further includes step (b-3) of discharging water from at least one of a feed water tank for replenishing the cooling water tank with water and a makeup water circulation passage for circulating the water between the cooling water tank and the feed water tank, after the step (a);
wherein the step (c) further includes step (c-3) for detecting a water temperature in at least one of the feed water tank and the makeup water circulation passage;
and wherein in the step (d), the group further includes a third water pump provided in the makeup water circulation passage.

19. The method according to claim 15, further comprising:
step (f) of continuing the circulation of the water in the step (d) while operating at least one of a first heater and a second heater, the first heater being provided in at least one of the cooling water circulating passage and the cooling water tank, to heat the cooling water and the second heater being provided in at least one of the hot water circulating passage and the hot water tank, to heat the hot water, if the step (a) is not performed and if one of the water temperatures detected in the step (c) is lower than a set temperature lower than the specified threshold temperature during suspension of the power generation operation of the fuel cell system.

20. The method according to claim 15,
wherein the step (c) further includes step (c-3) of detecting a water temperature in a feed water tank for replenishing the cooling water tank with water and a makeup water circulation passage for circulating the water between the cooling water tank and the feed water tank,
and wherein in the step (d), the group further includes a third water pump provided in the makeup water circulation passage.
